(19) United States
(12) Patent Application Publication
(10) Pub. No.: US 2025/0389352 A1
(43) Pub. Date: Dec. 25, 2025

(54) Concrete Conduit Device

(71) Applicant: Steven Earl Woods, JR., Canton, GA (US)

(72) Inventor: Steven Earl Woods, JR., Canton, GA (US)

(21) Appl. No.: 19/244,469

(22) Filed: Jun. 20, 2025

Related U.S. Application Data
(60) Provisional application No. 63/662,126, filed on Jun. 20, 2024.

(51) Int. Cl. F16L 5/00; H02G 3/22

(52) U.S. Cl. CPC F16L 5/00; H02G 3/22

(57) ABSTRACT

A conduit device is disclosed. The conduit device can have a concrete body, the concrete body having a first end portion and a second end portion spaced along a longitudinal axis. The first end portion defines a male protrusion having a shape. The second end defines a female receptacle that is configured to receive the shape of the male protrusion. The concrete body defines at least one bore extending continuously therethrough from the first end portion to the second end portion.

### CROSS-REFERENCE TO RELATED APPLICATION

This application claims priority to and the benefit of the filing date of U.S. Provisional Patent Application No. 63/662,126, filed Jun. 20, 2024, the entirety of which is incorporated by reference herein.

### FIELD

This disclosure relates to devices, systems, and methods for providing conduits for electrical cables.

### BACKGROUND

In certain situations, it can be advantageous to provide conduits within concrete (e.g., in an underground installation). For example, regulations or engineers can require electrical wiring to be provided in concrete. However, doing so can be a labor intensive, logistically difficult, and expensive project. Accordingly, an improved way to provide such an installation of conduit within concrete is desirable.

### SUMMARY

Disclosed herein, in one aspect, is a conduit device comprising a concrete body having a first end portion and a second end portion spaced along a longitudinal axis. The first end portion defines a male protrusion having a shape. The second end defines a female receptacle that is configured to receive the shape of the male protrusion. The concrete body defines at least one bore extending continuously therethrough from the first end portion to the second end portion.

In another aspect, a system comprises a plurality of conduit devices. The plurality of conduit devices include a first conduit device and a second conduit device. The plurality of conduit devices are arranged end-to end so that the female receptacle of the first conduit device of the plurality of conduit devices receives the male protrusion of the first end portion of the second conduit device.

Systems and methods of using the conduit device are also disclosed herein.

### BRIEF DESCRIPTION OF THE DRAWINGS

FIG. 1 illustrates a perspective view of an exemplary conduit device as disclosed herein.

FIG. 2 is a side view of the exemplary conduit device of FIG. 1.

FIG. 3 is a front view of the exemplary conduit device of FIG. 1.

FIG. 4 is a schematic diagram illustrating a test for measuring resistance to vertical shear between two engaged conduit devices.

FIG. 5 illustrates a system of conduit devices following a shear test to failure.

FIG. 6 is a side view of an exemplary system having a plurality of conduit devices as disclosed herein coupled with an anchor.

Various embodiments are described in detail below with reference to the accompanying drawings, wherein like reference numerals represent like elements, and wherein descriptions of like elements may not be repeated for every embodiment, but may be considered to be the same if previously described herein.

### DESCRIPTION OF THE PREFERRED EMBODIMENTS

The present invention can be understood more readily by reference to the following detailed description, examples, drawings, and claims, and their previous and following description. However, it is to be understood that this invention is not limited to the specific apparatuses, devices, systems, and/or methods disclosed unless otherwise specified, and as such, of course, can vary.

Any combination of the elements described herein in all possible variations thereof is encompassed by the invention unless otherwise indicated herein or otherwise clearly contradicted by context.

It must be noted that as used herein and in the appended claims, the singular forms “a,” “an,” and “the” can include plural references unless the context clearly dictates otherwise. Thus, for example, reference to “a bore” amounts to a disclosure of embodiments in which only a single bore is provided, as well as embodiments in which a plurality of such bores are provided.

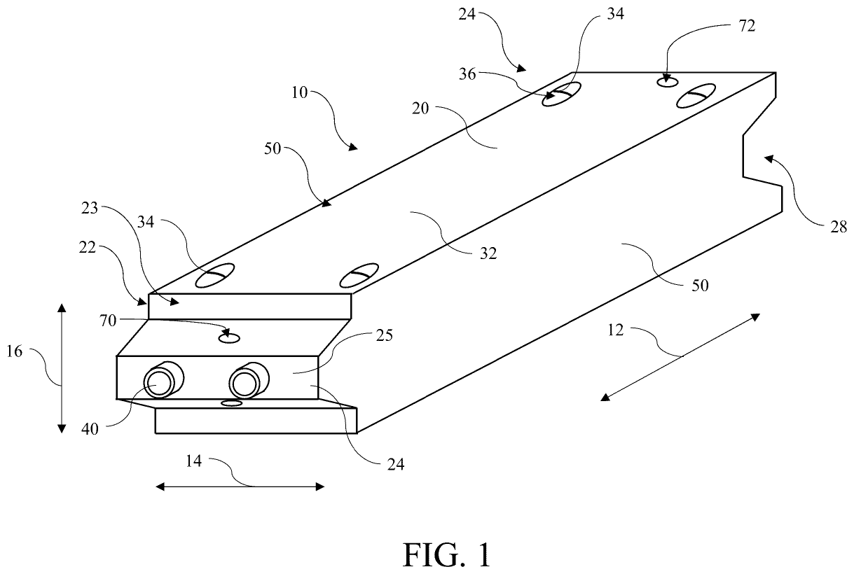

Referring to FIGS. 1-3, a conduit device 10 can comprise a concrete body 20, the concrete body having a first end portion 22 and a second end portion 24 spaced along a longitudinal axis 12. The first end portion 22 of the concrete body 20 can define a male protrusion 26 having a shape. The second end portion 22 of the concrete body 20 can define a female receptacle 28 that is configured to receive the shape of the male protrusion. The concrete body 20 can define at least one bore 30 extending continuously therethrough from the first end portion 22 to the second end portion 24.

The female receptacle 28 can have a shape that is complementary to the shape of the male protrusion 26. That is, the male protrusion 26 can have outer engagement surfaces that form a first shape, and the female receptacle 28 can have inner engagement surfaces that form a second shape that matches the first shape such that the engagement surfaces of the male protrusion are complementary to the engagement surfaces of the female receptacle. In this way, when two adjacent conduit devices are positioned end-to-end, a load can be distributed across surfaces of the male protrusion and female receptacle when a shear force is applied at an intersection between the two adjacent conduit devices.

In some aspects, the concrete body 20 can define a plurality of bores 30 extending continuously therethrough from the first end portion 22 (e.g., from a first end of the body) to the second end portion 24 (e.g., to a second end of the body). Optionally, the concrete body can define exactly two bores 30 extending continuously therethrough from the first end portion 22 to the second end portion 24. In a further aspect, the body 20 can define three or more bores 30. In some aspects, at least two bores 30 can be aligned along a transverse axis 14 that is perpendicular to the longitudinal axis 12. In further aspects, at least two bores 30 can be aligned along a vertical axis 16.

In some aspects, the concrete body 20 can have an upper side 32 and at least one lifting eye 34 (optionally, a plurality of lifting eyes) on the upper side of the concrete body. In some aspects, the at least one lifting eye 34 can be formed by metal elements that are partially embedded in the concrete body. Optionally, each lifting eye 34 of the at least one lifting eye can be provided in a respective recess 36 in the upper side 32 of the concrete body 20. In this way, each lifting eye 34 can remain at or below a highest surface of the upper side 32 of the concrete body. That is, the lifting eye(s) 34 need not project upwardly from the upper side 32 of the concrete body 20. In some aspects, the lifting eye(s) 34 can comprise a loop (or loops). In other aspects, each lifting eye(s) 34 can extend between sidewalls of the respective recess 36.

In exemplary aspects, the concrete body 20 can have a length along the longitudinal axis 12 from about 6 feet to about 15 feet.

The conduit device 10 can further comprise at least one tube 40. A respective tube 40 can be embedded within each bore 30 of the at least one bore. In some aspects, the tube(s) 40 can comprise polymer (optionally, polyvinyl chloride (PVC)). In some aspects, the at least one tube 40 can comprise a composite material (e.g., fiber reinforced polymer).

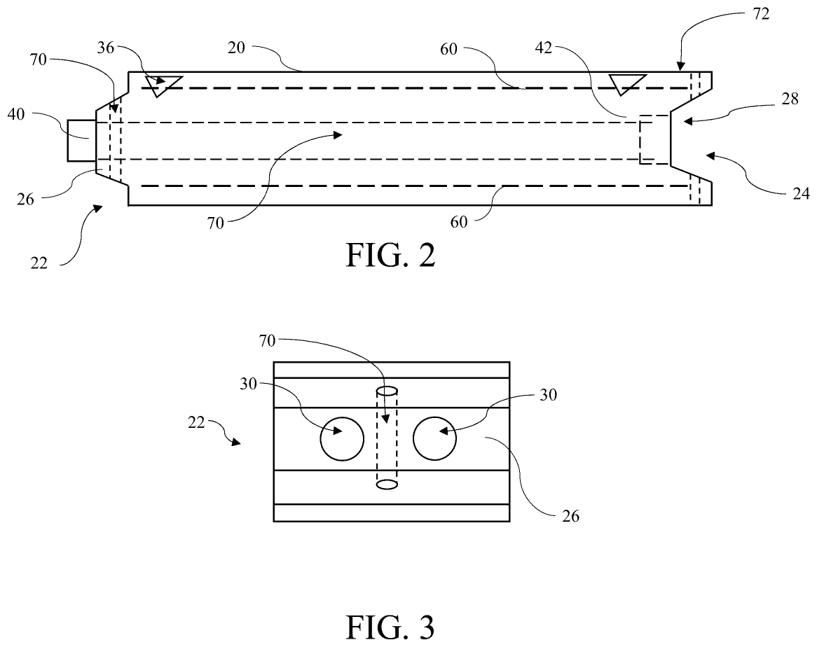

As illustrated in FIGS. 1-2, each tube 40 can protrude from the first end portion 22 of the concrete body 20 along the longitudinal axis 12. The second end portion 24 of the concrete body 20 can define at least one socket 42 that is configured to receive a respective protruding portion of at least one tube 40 of an adjacent conduit device. In this way, a plurality of conduit devices 10 arranged end-to-end can provide a continuously extending conduit.

In exemplary aspects, the at least one tube 40 can have an inner diameter from about 3 inches to about 5 inches. For example, the at least one tube 40 can have an inner diameter of about 4 inches. In other aspects, the at least one tube 40 can have an inner diameter from about 2 inches to about 8 inches, or from about 2 inches to about 4 inches, or from about 4 inches to about 6 inches.

The concrete body 20 can have opposed sides 50 spaced by a width along the transverse axis 14. In some aspects, the male protrusion 26 can extend continuously between the opposed sides 50 along the width of the concrete body. In other aspects, the male protrusion 26 can extend only a portion of the width of the concrete body 20. For example, the male protrusion 26 can extend at least 70%, at least 80%, or at least 90% of the width of the concrete body 20.

In some aspects, the male protrusion 26 can taper along a vertical axis 16 that is perpendicular to the longitudinal axis 12. For example, the male protrusion 26 can have an upper surface that slopes downwardly in a distal direction (moving away from a center portion of the body) relative to a horizontal plane and a lower surface that slopes upwardly in the distal direction. In further aspects, the male protrusion can have opposed side surfaces, spaced along the transverse axis 14, that taper distally. In this way, the male protrusion 26 can guide insertion into the female receptacle 28.

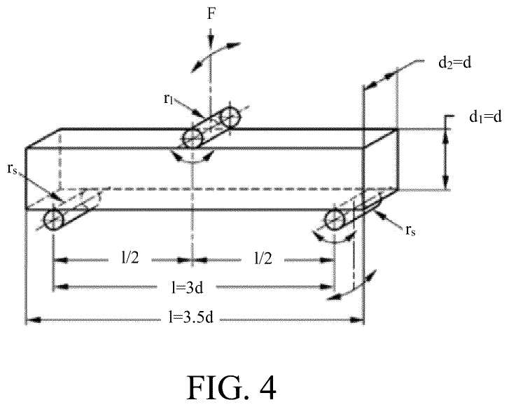

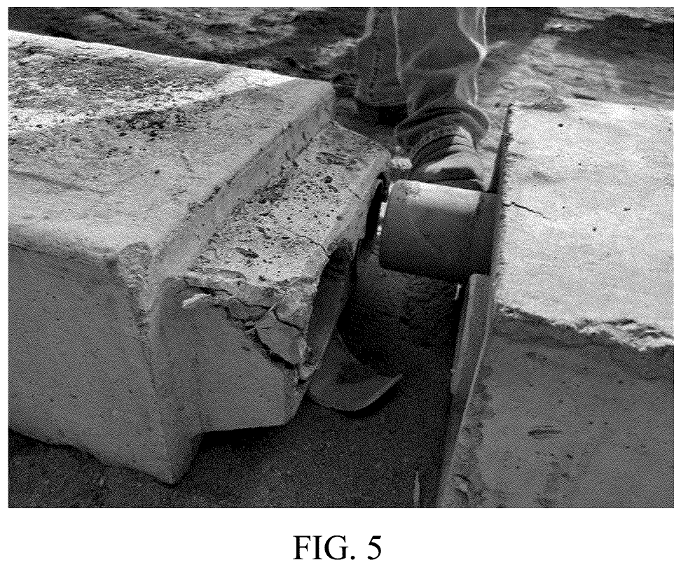

Optionally, the first end portion 22 can define exactly one male protrusion 26. By providing a conduit device having exactly one male protrusion 26 on the first end portion 22 and exactly one female receptacle 28 on the corresponding second end portion 24, the male protrusion 26 and female receptacle 28 can be sufficiently robust to provide substantial resistance to shear. For example, in some aspects, two conduit devices 10, arranged end-to-end, when subject to a load at a center as illustrated in the arrangement in FIG. 4 (supported by two rollers (rs and loaded by a third roller r₁) can cooperate to support a load of at least 5000 pounds-force, or at least 7500 pounds-force, or at least 10,000 pounds-force, or at least 12,500 pounds-force, or at least 15,000 pounds-force. It is contemplated that such resistance to loading can be critical for operating in certain environments. For example, the first end portion 22 can comprise a main body portion 23 from which the one male protrusion 26 extends. The main body portion 23 can have a front area (e.g., projected into a plane that is parallel to the vertical axis 16 and the transverse axis 14, and represented by the outer perimeter of the view shown in FIG. 3). Optionally, in these aspects, the one male protrusion 26 can cover at least 50% of the front area of the main body portion 23 of the first end portion 22. In some aspects, the male protrusion 26 can have a distal surface 25, and the distal surface can have an area that is approximately 50%, +/−15%, +/−10%, or +/−5% of the area of the first end portion 22 projected into said plane. In some aspects, the male protrusion 26 can project distally along the longitudinal axis by a distance from about 2 inches to about 6 inches, or from about 3 inches to about 5 inches. In some aspects, the male protrusion 26 can have a greatest vertical dimension (e.g., at a beginning of a taper) from about 4 inches to about 12 inches, or greater than 12 inches. In this way, the male protrusion 26 can support heavy loads.

In some aspects, the conduit device 10 can comprise at least one rebar segment 60 embedded within the concrete body 20. For example, in some optional aspects, the conduit device 10 can comprise at least one rebar segment 60 (optionally, a plurality of rebar segments) above the at least one bore 30 and at least one rebar segment (optionally, a plurality of rebar segments) below the at least one bore 30. For example, a plurality of rebar segments can be spaced vertically within the concrete body 20 and/or horizontally along the transverse axis 14.

In some aspects, each conduit device 10 can be configured to receive an anchor through each end to anchor an adjacent conduit device. For example, the first end portion 22 can define a first vertically extending through-bore 70. The second end portion 24 can define a second vertically extending through-bore 72. The first and second vertically extending through-bores 70, 72 can be aligned along the transverse axis 14 (optionally, centered between the opposed sides 50 of the concrete body). The first and second vertically extending through-bores 70, 72 can further be positioned along the longitudinal axis 12 so that a first adjacent conduit device, having received the male protrusion 26 of the first end portion 22 of the conduit device within the female receptacle 28 of the second end portion 24, permits coaxial alignment between the first vertically extending through-bore 70 of the conduit device and the second vertically extending through-bore 72 of the first adjacent conduit device.

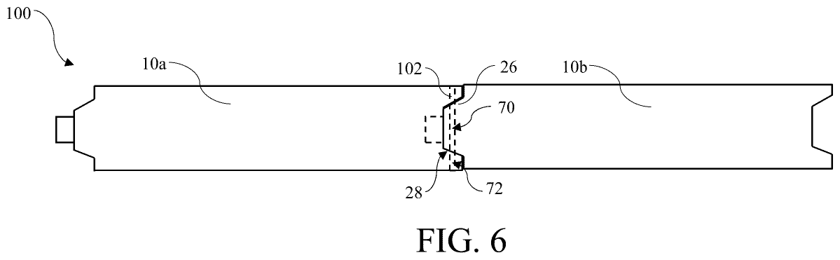

Referring to FIG. 6, in some aspects, a system 100 can comprise a plurality of conduit devices 10 arranged end-to-end so that the female receptacle 28 of a first conduit device 10a of the plurality of conduit devices receives the male protrusion 26 of the first end portion of a second conduit device 10b.

In some aspects, the first and second conduit devices 10a,b can be anchored together. For example, an anchor rod 102 can extend through the second vertically extending through-bore 72 of the first conduit device and the first vertically extending through-bore 70 of the second conduit device.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A conduit device comprising:
a concrete body comprising a first end portion and a second end portion spaced along a longitudinal axis,
wherein the first end portion defines a male protrusion having a shape,
wherein the second end defines a female receptacle that is configured to receive the shape of the male protrusion,
wherein the concrete body defines at least one bore extending continuously therethrough from the first end portion to the second end portion.

2. The conduit device of claim 1, wherein the at least one bore comprises a plurality of bores.

3. The conduit device of claim 2, wherein the concrete body defines exactly two bores extending continuously therethrough from the first end portion to the second end portion.

4. The conduit device of claim 1, wherein the concrete body has an upper side, wherein the conduit device further comprises at least one lifting eye on the upper side of the concrete body.

5. The conduit device of claim 1, wherein the concrete body has a length along the longitudinal axis from about 6 feet to about 15 feet.

6. The conduit device of claim 1, further comprising at least one tube, wherein a respective tube of the at least one tube is embedded within each bore of the at least one bore.

7. The conduit device of claim 6, wherein the at least one tube comprises polyvinyl chloride (PVC).

8. The conduit device of claim 6, wherein each tube of the at least one tube protrudes from the first end portion of the concrete body along the longitudinal axis.

9. The conduit device of claim 8, wherein the second end portion of the concrete body further defines at least one socket, wherein each socket of the at least one socket is configured to receive a respective protruding portion of each tube of the at least one tube of an adjacent conduit device.

10. The conduit device of claim 6, wherein the at least one tube has an inner diameter from about 3 inches to about 5 inches.

11. The conduit device of claim 1, wherein the concrete body has opposed sides spaced by a width along a transverse axis that is perpendicular to the longitudinal axis, wherein the male protrusion extends continuously between the opposed sides along the width of the concrete body.

12. The conduit device of claim 1, wherein the concrete body has opposed sides spaced by a width along a transverse axis that is perpendicular to the longitudinal axis, wherein the male protrusion extends across at least 90% of the width of the concrete body.

13. The conduit device of claim 1, wherein the male protrusion tapers along a vertical axis that is perpendicular to the longitudinal axis.

14. The conduit device of claim 1, wherein the first end portion defines exactly one male protrusion.

15. The conduit device of claim 1, wherein the female receptacle has a shape that is complementary to the shape of the male protrusion.

16. The conduit device of claim 1, further comprising at least one rebar segment embedded within the concrete body.

17. The conduit device of claim 1, wherein the first end portion defines a first vertically extending through-bore, wherein the second end portion defines a second vertically extending through-bore, wherein the first and second vertically extending through-bores are aligned along a transverse axis that is perpendicular to the longitudinal axis, wherein the first and second vertically extending through-bores are positioned along the longitudinal axis so that a first adjacent conduit device having a second end portion, first and second vertically extending through-bores, and a female receptacle, and identical geometry to the conduit device, having received the male protrusion of first end portion of the conduit device within the female receptacle of the second end portion, permits coaxial alignment between the first vertically extending through-bore of the conduit device and the second vertically extending through-bore of the first adjacent conduit device.

18. A system comprising:
a plurality of conduit devices as claim 1, the plurality of conduit devices comprising a first conduit device and a second conduit device, wherein the plurality of conduit devices are arranged end-to end so that the female receptacle of the first conduit device of the plurality of conduit devices receives the male protrusion of the first end portion of the second conduit device.

19. The system of claim 18, wherein, for each conduit device of the plurality of conduit devices:
the first end portion defines a first vertically extending through-bore,
the second end portion defines a second vertically extending through-bore, and
the first and second vertically extending through-bores are aligned along a transverse axis that is perpendicular to the longitudinal axis,
wherein the second vertically extending through-bore of the first conduit device is coaxial with the first vertically extending through-bore of the second conduit device, and
wherein the system further comprises an anchor rod extending through the second vertically extending through-bore of the first conduit device and the first vertically extending through-bore of the second conduit device.

20. The system of claim 18, wherein the system is configured to support a load of at least 5000 pounds-force between the first and second conduit devices without failure.
